(19) United States
(12) Patent Application Publication
(10) Pub. No.: US 2002/0094063 A1
(43) Pub. Date: Jul. 18, 2002

(54) Laser plasma EUV light source apparatus and target used therefor

(75) Inventors: Yasuhiko Nishimura, Aichi (JP); Hirozumi Azuma, Aichi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: TOYOTA MACS INC., Toyota-City (JP)

(21) Appl. No.: 10/032,551

(22) Filed: Jan. 2, 2002

(30) Foreign Application Priority Data
Jan. 12, 2001 (JP) 2001-004756

(51) Int. Cl. H05G 2/00

(52) U.S. Cl. 378/119; 378/143

(57) ABSTRACT

The present invention intends to generate an electromagneticwave of wavelength in an EUV area repeatedly by irradiating laser beam in high frequency more than few kHz. For such purpose, a laser plasma EUV light source apparatus is comprised of a vacuum chamber, a target disposed in the vacuum chamber, a beam irradiate means for irradiating energy beam to the target, an input optical system for introducing energy beam to the target, an output optical system being communicated with the vacuum chamber for introducing electromagneticwave generated from the target, a shield device for protecting at least one of the input optical system and output optical system from spattering particle, and a wave length select device for selecting from electromagneticwave an electromagneticwave at wavelength in the EUV area. By such construction, generation of the debris can be restricted, and generated debris is shielded by the shield device 4. In addition, the target can be supplied for long time and the laser plasma EUV light source apparatus can be made compact.

### BACKGROUND OF THE INVENTION

1. Field of the Invention

This invention relates to a laser plasma EUV light source apparatus emitting an electromagneticwave of a EUV (Extreme Ultra Violet) area in wavelength of 10 nm to 15 nm, and a target used for the laser plasma EUV light source apparatus. The electromagneticwave of wavelength in EUV area extracted from the laser plasma EUV light source apparatus of the present invention is used for a EUV lithography, an electronic field and a chemical material field.

2. Related Background Art

Recently, a X-ray light source apparatus generating a soft X-ray by irradiating laser beam to a predetermined target disposed in a vacuum chamber has been known. For example, the laser beam is focused to a surface of the target made of a plate-like or pillar-like solid metal to create a laser plasma of high density, and the soft X-ray generated from the freely expanded plasma is introduced externally through a X-ray optical system.

Also, a laser beam of high energy having intensity more than 10 to 100 MW/cm² has been developed, an apparatus to generate a laser plasma soft X-ray by using this laser beam for excitation has been proposed (Japanese Patent Laid-open No. 7-128500). Application of this apparatus for a X-ray lithography or X-ray microscope has been expected.

However, in such X-ray light source apparatus the exciting laser beam is irradiated intermittently with keeping few tens of minutes to avoid drawback due to a overheating, which makes continuous extraction of the soft X-ray difficult. Recently, as have been disclosed in Japanese Patent Laid-open No. 7-94296, the laser plasma soft X-ray is generated by repetition of 1 Hz or 10 Hz by using the solid laser of which pulse line is waveform-controlled.

In addition, Japanese Patent Laid-open No. 8-194100 and U.S. Pat. No. 4,896,341 have proposed to generate a laser plasma soft X-ray by high frequency repeatedly without returning pressure of the vacuum chamber to the normal pressure, by using the solid laser of which pulse line is waveform-controlled and a tape-shape target.

However, in the X-ray light source apparatus using the laser beam for excitation , a spattered particle comprising burnt and decomposed material and a crushed material (called “debris” hereinafter) is emitted from the target together with the soft X-ray and is spattered widely. If the laser beam for excitation of high energy more than 10 MW/cm² is used, the debris is emitted by especially large velocity to spatter more widely. The debris attached to the X-ray optical system decreases amount of X-ray extracted from the apparatus, and deteriorates an element(s) of the X-ray optical system. Also, the debris attached to the laser optical system decreases utilizing efficiency of the exciting laser beam. In addition, if the laser plasma soft X-ray is generated repeatedly for long time by using the tape-shape target, large amount of debris is explodedly generated in a short time to attach to the X-ray optical system and the laser optical system.

In view of this, in the conventional X-ray light source apparatus pressure in the vacuum chamber is returned to the normal pressure in every irradiation of the laser for excitation of few tens to few thousand times to remove the debris attached to the X-ray optical system and the laser optical system. For this reason, the soft X-ray can hardly be extracted continuously for a long time, which results in low workability and productivity.

Japanese Patent Laid-open Nos. 4-112498 and 8-194100 have disclosed apparatuses in which a polymer film is interposed between a target and a X-ray optical system so that soft X-ray is introduced to the X-ray optical system through the polymer film. Also, Japanese Patent Laid-open No. 10-26699 has proposed usage of a polymer film to prevent attachment of the debris to an go-out window for laser for excitation. In such arrangement, the debris being attached and trapped by the polymer film, would not attach to the X-ray optical system and the laser optical system.

Also, Japanese Patent Laid-open No. 10-55899 has disclosed to continuously generate soft X-ray by injecting and collecting a particular-like metal to a focus position of the laser for excitation, and Japanese Patent Laid-open No. 10-221499 has disclosed a method for generating soft X-ray by using an apparatus for injecting and collecting gas containing particular-like metal.

By the way, a fine manufacturing technique which uses an electromagneticwave of wavelength in EUV area as the light source has attracted attention. On account of overlapping of the wavelength in the EUV area with the soft X-ray area, usage of the above mentioned conventional X-ray light source apparatus may be tried. However, in the above fine manufacturing technique, the electromagneticwave of wavelength in the EUV area needs to be generated by repetition of high frequency more than few kHz.

In the method for shielding the debris by the polymer film of the conventional X-ray light source apparatus, the debris floating in the vacuum chamber can hardly be shielded perfectly, so that the debris may break into the output optical system which introduces the electromagneticwave generated from the target.

Also, in the method which forms the target by injecting the particle-like metal, the soft X-ray of high brightness can hardly be generated, and the injection and the laser beam for exciting can hardly be synchronized, although generation of the debris can reduced.

In addition, if the tape-like target to be wound is used, the supplying velocity thereof should be set faster to irradiate the laser beam in high frequency of more than few kHz. Consequently, the time for winding up the whole tape becomes shorter, which makes continuous and long driving of the apparatus difficult. Elongating tape length can solve this problem, but it increases wound thickness of the target to thereby make the light source apparatus bulky.

Due to large consuming amount of the target per a unit time, the debris is generated by large amount and attaches to the optical system, which necessitates frequent periodical cleaning.

### SUMMARY OF THE INVENTION

The present invention has been made in view of the above circumstances and intends to generate an electromagneticwave of wavelength in a EUV area repeatedly with restricted generation of the debris, by irradiating the laser beam in high frequency of more than few kHz.

The target of the present invention is disposed and used in the laser plasma EUV light source apparatus by irradiation of energy beam is characterized by that the target is comprised of a polymer film having film thickness of 10 to 100 μm, and a target material held in the polymer film.

In the target of the present invention, the target material desirably comprises Al, Cu, Sn, Si or an alloy thereof. The target material is desirably forms a metal layer on the surface of the polymer film and has film thickness of 1 to 20 μm.

The laser plasma EUV light source apparatus according to the present invention is comprised of a vacuum chamber, a target disposed in the vacuum chamber, a beam irradiate means for irradiating energy beam to the target, an input optical system for introducing energy beam to the target, an output optical system being communicated with the vacuum chamber for introducing electromagneticwave generated from the target, a shield device for protecting at least one of the input optical system and output optical system from spattering particle, and a wavelength select device for selecting from electromagneticwave an electromagneticwave at wavelength in the EUV area.

The laser plasma EUV light source apparatus desirably uses the above mentioned target of the present invention, and desirably has a target drive device for supplying the target to the focus position of the energy beam continuously or intermittently.

For example, the target can be a tape-like target, the target drive device can have a drive portion for feeding out the tape-like target and a wind portion for winding up the tape-like target. The focus position of the energy beam can be disposed between the drive portion and the wind portion.

The input optical system desirably has a beam vibrate means for vibrating the energy beam in a plane including an extract direction of the electromagneticwave of wavelength in EUV area. The vibrating direction of the energy beam is desirably perpendicular to move direction of the tape-like target.

The shield device desirably has a shield film made of a silicon nitride and an reinforce film to protect the output optical system from spattering particles. The shield device desirably has move means for moving the shield film.

According to study by the inventor, when the energy beam is irradiated to the polymer film, not only plasma gas is generated by energy of the energy beam, but in some kinds of polymer film a portion aground the focus position of the polymer film is gased and does not generate debris. Accordingly, usage of such polymer film can restrict generation of the debris.

In view of the above, the target of the present invention is comprised of the polymer film and the target material held in the polymer film.

The polymer film contains the target material therein to give intensity to the target, which enables the target to be supplied to the focus position of the energy beam continuously. In the target of the present invention, if the energy beam is irradiated to the polymer film, generation of the debris is restricted.

The polymer film is desirably made of material which is easily gased, when the energy beam is irradiated thereto, and which can be formed by the element selected from carbon, hydrogen, oxygen and nitrogen. With usage of such polymer films, the elements are easily gased to CO, CO₂, H₂O. N₂ by irradiation of the energy beam, and the debris is not generated. For such polymer film, polyethylene, polypropylene, polyethyleneterephtalate, polycarbonate, polyimide, and parilene are illustrated.

Thickness of the polymer film is desirably 10 to 100 μm, and thickness not less than 30 μm is more desirable. When thickness is smaller than 10 μm, the portion of the target around the focus position of the energy beam is broken widely, so that supplying the target by the target drive device to be explained later continuously or intermittently becomes difficult. When thickness is not less than 10 μm, the portion corresponding to the focus position of the energy beam is melted but the surrounding portion is hardly broken. Although, an upper limit of thickness is not restricted, thickness not more than 100 μm is desirable in view of easiness for supplying by the target drive device, easiness for manufacturing and winding length and winding thickness to the reel.

The target material is desirably made of the chemical element of metal or alloy of metals selected from Al, Cu, Sn and Si, and Cu or Cu alloy which merely generates small amount of debris is more desirable. The target material can be contained in the polymer film in fine particle state or laminated on surface of or internal of the polymer film.

The target material desirably has particle diameter of 0.1 to 80 μm to be contained in the molecule film in the fine particle state to have thickness of 5 to 10 μm in thickness of direction of the polymer film. When particle diameter is smaller than 0.1 μm intensity of the electromagneticwave generated becomes smaller. To the contrary, when the particle diameter is more than 80 μm, the portion which has not made into plasma is melted by energy of the energy beam, so that particles are melted to create large particle having particle diameter not less than than 100 μm. Thus, large amount of debris is generated.

If the particles are contained in the polymer film in the thickness direction thereof by thickness smaller than 5 μm, intensity of the electromagneticwave becomes small due to shortage. If the particles are contained to have thickness larger than 10 μm large amount of debris is generated due to excess.

The particle can have various shapes such as foil shape, cubic shape and amorphous shape. The particles can be dispersed and contained in the whole polymer film or can be contained only on the surface thereof. The particles contained on the surface of the polymer film desirably has foil shape, and the particles contained in the polymer film desirably has cubic shape.

For producing such fine metal particles, an atomize method, a crush method and an explode method can be used. The atomize method includes a gas atomize method, water atomize method and centrifugal atomize method. They produce metal particle of fine particle state, by blowing out a melted metal into vacuum or solution, or spattering the melted metal by centrifugal force. In the crush method, an aimed metal and a metal harder than it are put into the chamber and rotated or vibrated to be crushed. In the explode method, a metal piece and an explosive are put into the chamber to be exploded for producing the fine particles. The atomize method can produce the relatively well-shaped spherical fine particles, and the explode method can produce the metal particle of fine particle state from relatively harder metal.

In containing the particles of fine particle state in the polymer film, the particles can be varied in the polymer film or are attached to the surface thereof. In both cases, the particles are desirably dispersed and contained uniformly. For varying the particles, the method in which the particles are mixed into the polymer solution to form the film by the spin coat method, the method in which particles are mixed into the molten polymer to form the film, and method in which the particles are nipped between the two polymer films by the laminate method, can be adopted. For attaching the particles to the surface of the polymer film, the method in which the particles supplied to the surface of melted polymer film is melted, or method using adhesive, can be adopted.

In forming the metal layer, thickness thereof is desirably 1 to 20 μm. When the film thickness is thinner than 1 μm, a pinhole may be formed in the metal layer, so that spectrum of the electromagneticwave generated at the focus position of the energy beam changes. When film thickness of the metal layer is thicker than 20 μm, amount of the debris generated in irradiation of the energy beam becomes larger.

The metal layer can be laminated on the surface or internal of the polymer film. For forming the target which contains the metal layer on the surface of the polymer film, the metal is manufactured into a foil having thickness of 1 to 20 μm, and melted or adhered to the polymer film. Also the metal layer can be formed on the polymer film by evaporating.

The laser plasma EUV light source apparatus of the present invention is comprised of a vacuum chamber, a target disposed in the vacuum chamber, a beam irradiate means for irradiating energy beam to the target, an input optical system for introducing energy beam to the target, an output optical system provided communicated with the vacuum chamber for introducing electromagneticwave generated from the target, a shield device for protecting at least one of the input optical system and output optical system from spattering particle, and a wave length select device for selecting from electromagneticwave an electromagneticwave of wavelength in a EUV area.

As the target, a target made of the above mentioned polymer film and the target material can be used.

As the beam irradiate means, a device irradiating the laser beam of intensity not less than 10 MW/cm² can be used. The laser beam of intensity not less than 100 MW/cm² is especially desirable. For example, a YAG laser, glass laser, excimer laser, CO₂ gas laser, and titanium sapphire laser and a color laser can be used. Usage of the laser beam having intensity not less than 100 MW/cm² can generate the electromagneticwave of wavelength in the EUV area with efficiency.

The laser plasma EUV light source apparatus of the present invention has the target drive device for supplying the target to the focus position of the energy beam continuously or intermittently. Here, the target desirably has the sheet shape or the tape shape. Such shapes of the target are convenient to be supplied to the focus position of the energy beam continuously or intermittently by the target drive device. As a result, the electromagneticwave of wavelength in the EUV can be generated continuously for a long time without releasing vacuum in the vacuum chamber.

The target drive device can have a pair of reels, the tape-like target wound on one reel being to be wound on other reel. Rotating the reels continuously supplies the target to the focus position continuously, while rotating the reels intermittently supplies the target to the focus position intermittently.

The sheet-shape target having relatively wide area can be supplied continuously or intermittently by rotation or parallel movement. Alternately, the sheet-like target can be wound on a surface of pillar-like member which is rotated.

For generating the electromagneticwave of wavelength in the EUV area continuously in higher repetition for a long time, the energy beam is desirably vibrated in direction perpendicular to a feed direction of the target. The laser beam can be irradiated by repetition of high frequency not less than 6 kHz, which enables continuous driving of the apparatus for long time.

Vacuum degree of the vacuum chamber can be set in 10⁻¹⁰ to 10⁻³ Pa. As the input optical system a lens and a glass window can be adopted, while as the output optical system a focus mirror, a plane image-forming type incidence spectroscope and a wavelength select filter can be adopted.

The shield device protects at least one of the input optical system and the output optical system from the debris. Even if the debris is generated at the target, for some reason, attachment thereof to the input optical system and the output optical system is prevented by the shield device. As a result, longer continuous driving of the apparatus becomes possible. As the shield device, a shield film such as polymer film disclosed in Japanese Patent Laid-open No. 8-194100 can be used.

For example, for restricting attachment of the debris to the output optical system, the debris is most effectively removed at position adjacent to the output optical system. In view of this, the shield device including a supply device for supplying a shield film made of a polymer film in direction perpendicular to the electromagneticwave path, and desirably a collect device for collecting the shield film to which the debris is attached, can be disposed between the target and the output optical system. The debris floating in the vacuum chamber attaches to the shield film, whereby attachment of the debris to the output optical system is prevented.

The shield film to which the debris is attached is collected by the collect device, and new shield film is disposed between the target and the output optical system by the supply device, so that decrease of permeability is prevented. Also, the supply device and collect device can be driven in the vacuum chamber, they can be used continuously for a long time without causing vacuum leakage of the apparatus for irradiation of the energy beam more than few tens of thousand times. Thus, the workability and productivity of the apparatus are improved. A shield device of similar to the above construction is desirably provided for the input optical system.

The polymer film as the shield film desirably has high permeability of the electromagneticwave of wavelength in the EUV area, and is desirably made of polypropylene and polyparaxylene. The polymer film desirably has thickness of 0.05 μm to 3 μm. If thickness is thicker than 3 μm permeability is decreased, while if it is thinner than 0.05 μm intensity becomes poor.

Constructions of the supply device and collect device can be modified according to shape of the polymer film. For example by holding the polymer film in a frame made of metal or resin, the supply device and collect device can be constructed as a cartridge.

As the shield film, a silicon nitride film is more desirable than the above mentioned polymer film. The silicon nitride film has selectively high permeability of the electromagneticwave at wavelength of 11 to 13 nm in the EUV area. However, as film thickness become thicker permeability in each wavelength decreases so film thickness is desirably not more than 0.2 μm.

The silicon nitride film having film thickness not more than 0.2 μm is easily broken in the chemical element state. Due to difference of the lattice constant between the silicon nitride and silicon which forms the base plate in producing the shield device, the silicon nitride film is hardly held in the shield device in the tape state, different from conventional tape-shape polymerfilm. Also, the silicon nitride film has small durability against collision by the debris and has short life time.

In view of the above, the silicon nitride film is desirably comprised of a frame-like base plate having an open portion, and a shield film covering at least the opening of the open portion to allow permanence of the electromagneticwave of wavelength in EUV area but to prevent passage of the debris. The shield film is comprised of a silicon nitride film having thickness of 0.05 to 0.2 μm, and a reinforce film formed on a surface of the silicon nitride film to attenuate stress thereof and to reinforce the silicon nitride film.

That is, the surrounding portion of the silicon nitride film is supported by the base plate, and reinforce film attenuates stress of the film portion and reinforces it. Thus, the shield device can be held stably for a long time, and has long lifetime. Also, due to supporting of the shield film by the frame of the base plate, dimension of the opening of the shield film can be selected longer corresponding to intensity thereof. This allows permanence of the electromagneticwave of wavelength in the EUV area in relatively wide area, and makes holding of the shield device on the shield device stably. Further, by using plural openings sequentially, the laser plasma EUV light source apparatus can be driven continuously for a long time with preventing decrease of permeability caused by attachment of the debris.

The reinforce film sufficiently attenuates stress of the silicon nitride film and reinforces it, so various oxide thin films or a polymer thin film can be used. Among them, a silicon dioxide film having thickness of 0.05 to 0.1 μm, a polypropylene film having thickness of 0.05 to 0.2 μm, or parilene film having thickness of 0.05 to 0.2 μm can be desirably selected. Such reinforce film can reinforce the silicon nitride film with maintaining high permeability. If thickness becomes thinner reinforce effect can hardly be obtained, while thicker thickness decreases the permeability. Also, wavelength of the electromagneticwave which is permeating can be selected according to kinds of the reinforce film.

The reinforce film can be laminated on the silicon nitride film laminated on the base plate, or on the reinforce film laminated on the base member the silicon nitride film can be laminated. When the silicon dioxide film as the reinforce film is formed on the silicon nitride film, the silicon nitride film can be laminated on the silicon dioxide film to form the shield film of three layer construction. In this case, total film thickness of two silicon nitride films is desirably 0.05 to 0.2 μm.

The shield film desirably has at outermost surface a thin film made of metal selected from aluminium and beryllium and has thickness of 0.005 to 0.5 μm. Such thin film can shield permanence of visible light. When thickness of the thin film is smaller than 0.005 μm, shield effect can hardly be obtained, while thickness thicker than 0.5 μm decreases permeability of the electromagneticwave of wavelength in the EUV area.

Desirably, the shield device is mounted on the laser plasma EUV light source apparatus detachably, which makes exchange of the shield device when permeability of the shield film is decreased due to attachment of the debris easier.

The base plate desirably has at the open portion plural openings each having area of 4 to 100 mm². The shield device is movable along surface of the base plate, so that the electromagneticwave of wavelength in the EUV area can permeate each opening. By moving the opening of the base plate, the electromagneticwave permeates new opening to which debris is not attached. The shield film can be exchanged with new shield film without returning pressure in the vacuum chamber to normal pressure, whereby the apparatus can be driven continuously for a long time.

Material of the frame-like base plate having the open portion is not restricted, but laminating the thin silicon nitride film and the reinforce film on the base plate having opening in producing the shield film is very difficult. For this reason, producing method using a photoresist is desirably used.

At least on one surface—on only one surface or on both surfaces—of the base plate not having the opening, the silicon nitride film of thickness 0.05 to 0.2 μm is formed. The silicon nitride film can be formed by depositing or evaporating the silicon nitride on the surface of the base plate. By using the silicon base plate, the silicon nitride film can be formed extremely easily by only the nitride treatment.

That is, firstly one surface of the silicon base plate is subjected to the nitride treatment to form the silicon nitride film thereon. Here, the nitride treatment can be a gas nitride method using ammonia, a liquid nitride method using KCN, or an ion nitride method.

Next, on the surface of the silicon nitride film formed on one surface of the base plate, the reinforce film is formed. The reinforce film is formed by depositing or evaporating the silicon dioxide by thickness of 0.05 to 0.1 μm. Alternately, it is formed by depositing polymer substance such as polypropylene or parilene by the CVD method or the PVD method.

On other surface of the base plate not having the reinforce film the resist film (negative-type or positive-type) is formed, and a predetermined opening is formed in the resist film by photoresist method. In forming the opening, the resist film is exposed, being masked by a masking member to remove the exposed portion or non-exposed portion. As mentioned above, forming plural openings is desirable.

Next, only the base plate or both of the silicon nitride film and the base plate is etched through the opening to form the frame-like base plate having the open portion. Finally, the resist film is removed. In this way, the shield device on of which one surface the silicon nitride film and reinforce film covering the opening is formed, and on of which other surface the surface of the flame-like base plate having the open portion appeared, is formed.

The silicon nitride film can be formed on the reinforce film firstly formed on the base plate. As mentioned above, the thin film having thickness of 0.005 to 0.5 μm and made of at least one metal selected from aluminium and beryllium can be formed on the outermost surface of the shield film by depositing or evaporating.

The wavelength select device is comprised of a disperse portion for dispersing the electromagneticwave generated from the target into electromagneticwaves having various wavelengths, and a select portion for extracting the electromagneticwave of single wavelength from the electromagneticwaves dispersed.

As the disperse portion, a spectroscope, a diffraction grating, a multi-layer half mirror film and a zone plate can be adopted. As the select portion a space slit is adopted. The space (gap) slit is comprised of two sheets of metal plates disposed side by side with leaving gap therebetween and a frame, and extends in direction perpendicular to the wave length disperse portion. Portion other than the narrow gap shields the electromagneticwave. Narrow width of the gap can limit the width of spectrum, and elongated length of the gap can permeates larger amount of electromagneticwave.

The select portion can be fixed to extract the electromagneticwave of particular wavelength, but constructing select portion movable in the wavelength disperse direction of the electromagneticwave which is wavelength-dispersed is desirable. Such construction of the wavelength select portion enables to selectively extract the electromagneticwave of various wavelength to be used as the single color light source.

For example, when a diffraction grating is used as the disperse portion, a following equation (1) is established between the incident angle α of the electromagneticwave injected into the diffraction grating, and the outgoing angle β of the electromagneticwave of predetermined wavelength λ dispersed according to wavelength. Here, N means the number of grooves of the refraction grating, and k is the number of the order.

With using the equation (1) the outgoing angle β of the electromagneticwave of predetermined wavelength λ is calculated, and height H from the surface of diffraction grating to the image-forming position can be calculated with using an equation (2) by inputting distance L from the diffraction grating to wavelength select device. By constructing the wavelength select device to be moved to the image-forming position, the electromagneticwave of desired wavelength can be extracted from the electromagneticwave wavelength-dispersed.

Nkλ=sin α+sin β (1)

H=L cot β (2)

The electromagneticwave of predetermined wavelength selected by the select portion can be observed by a X-ray detect device such as X-ray CCD camera, a microchannel plate or a streak camera disposed ahead of the wavelength select device. By disposing a X-ray microscope, a EUV lithography evaluate device and a photoelectric spectroscope apparatus, the electromagneticwave can be used in various field as the single color light source.

The laser plasma EUV light source apparatus of the present invention desirably includes a regulate member disposed between the target and the output optical system for cutting the electromagneticwave of high order. The electromagneticwave having been cutted the electromagneticwave of high order thereof comes in the wavelength select device to be further narrowed in a band zone thereof, whereby the electromagneticwave of single wavelength can be extracted more securely. The regulate member can be made of silicon nitride film.

The input optical system desirably includes a beam vibrate means for vibrating the energy beam in a plane including extract direction of the electromagneticwave of wavelength in the EUV area. By irradiating the energy beam with vibrating, whole surface of the target can be used effectively without loss. If the driving time of the apparatus is equivalent, amount of the target disposed in the vacuum chamber can be reduced, and laser plasma EUV light source apparatus can be made compact.

As the beam vibrate means, a mirror for coming in the energy beam to the vacuum chamber can be vibrated. Amplitude of vibration is selected corresponding to shape of the target, being normally 10 to 30 mm on the target.

When the target drive device for moving the tape-like target in the elongate direction is used, the energy beam is desirably vibrated in direction perpendicular to the moving direction of the target. The tape-like target can be used without loss, so that long and continuous driving of the apparatus becomes easier.

According to the laser plasma EUV light source apparatus and the target used therefor according to the present invention, the electromagneticwave of wavelength in the EUV area can be generated repeatedly in high frequency not less than few kHz. Consequently, stable and long continuous driving of the laser plasma EUV light source apparatus is realized.

### BRIEF EXPLANATION OF THE DRAWINGS

FIG. 1 is an explanative cross-section showing a schematic construction of the laser plasma EUV light source apparatus of an embodiment 1 according to the present invention.

FIG. 2 is a perspective view showing essential parts of the laser plasma EUV light source apparatus of the above embodiment 1.

FIG. 3 is perspective a view of the target drive device used in the laser plasma EUV light source apparatus of the above embodiment 1.

FIG. 4 is a cross-section of the target of the above embodiment 1.

FIG. 5 is a cross-section of essential parts of the output optical system used in the laser plasma EUV light source apparatus of the above embodiment 1.

FIG. 6 is a spectrum view of the electromagneticwave generated from aluminium as the target in the laser plasma EUV light source apparatus of the above embodiment 1.

FIG. 7 is a spectrum view of the electromagneticwave generated from tin as the target in the laser plasma EUV light source apparatus of the above embodiment 1.

FIG. 8 is a spectrum view of the electromagneticwave generated copper as the target in the laser plasma EUV light source apparatus of the above embodiment 1.

FIG. 9 is a graph showing relation between a gather angle and deposited amount of debris when aluminium and copper are used as the target in the above embodiment 1.

FIG. 10 is a cross-section showing essential parts of the laser plasma EUV light source apparatus in an embodiment 2 according to the present invention.

FIG. 11 is a perspective view of the X-Y stage used in the laser plasma EUV light source apparatus in the above embodiment 2.

FIG. 12 is an explanation view showing a manufacturing method of a shield portion used in the laser plasma EUV light source apparatus in the above embodiment 2.

FIG. 13 is a graph showing relation between the wavelength and permeability of electromagneticwave in which a debris is deposited by 0.03 μm when copper is used as target.

### PREFERRED EMBODIMENT OF THE INVENTION

A preferred embodiment of the present invention will be explained with reference to attached drawings. Hereinafter, the invention will be explained in detail through an embodiments and an experimental sample.

(Embodiment 1)

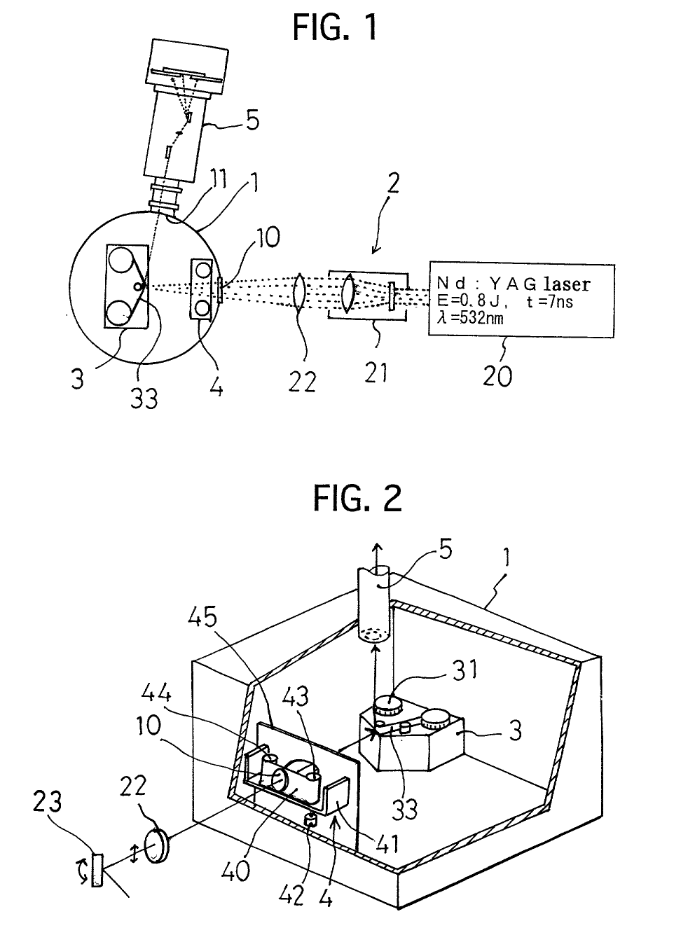

An outline of a laser plasma EUV light source apparatus of one embodiment according to the present invention is shown in FIGS. 1 and 2. This laser plasma EUV light source apparatus is mainly comprised of a vacuum chamber 1, a laser device 2 disposed outside of the vacuum chamber 1, a target drive device 3 disposed inside the vacuum chamber 1, a debris shield device 4 disposed in the vacuum chamber 1, and a plane image-forming type incidence spectroscope 5 connected to one side wall of the vacuum chamber 1.

To the vacuum chamber 1 an exhaust device (not shown) is connected to reduce pressure therein down to 10⁻⁴ Pa. On one side wall of the vacuum chamber 1 a laser incidence window 10 made of quartz glass is provided. On one side wall of the vacuum chamber 1 a connect port 11 for connecting the plane image-forming type incidence spectroscope 5 is formed.

The laser device 2 is comprised of a main body 20 emitting YAG laser beam (E=0.8 J, t=7 ns, λ=532 nm) using Nd, a beam expander 21 and a focus lens 22. The focus lens 22 is disposed coaxially with the laser incidence window 10.

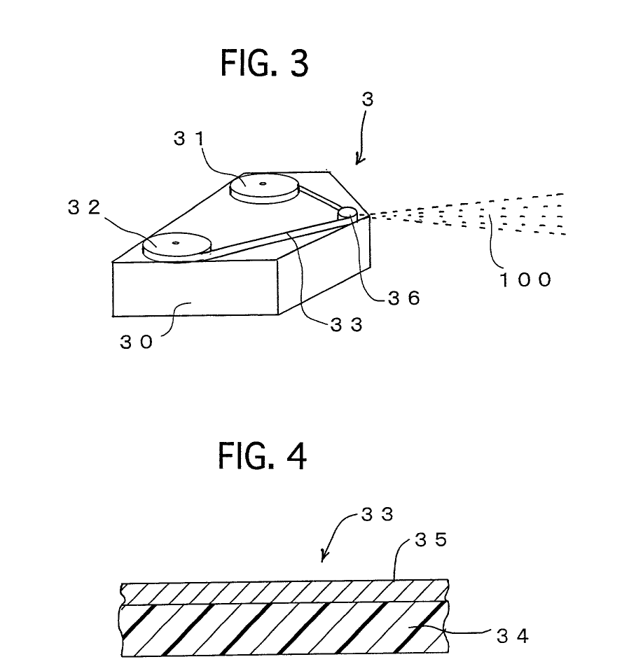

The target drive device 3 is, as shown in FIG. 3, comprised a pair of reels 31, 32 rotatably held on the base 30, a target 33 disposed between the paired reels 31 and 32, and a motor (not shown).

The target 33 elongates like a tape, and as shown in FIG. 4 has a two layer construction comprising a transparent film layer 34 made of polyethylene, and a metal layer 35 formed by joining metal foils and laminated on the film layer 34. One end and other end of the target 33 are respectively connected to one reel 31 and other reel 32, so that the target 33 is wound up from one reel 31 to other reel 32 continuous by the drive motor.

The surface of the metal layer 35 opposes to the laser beam at the focus position 36 and the portion of the target 33 to which laser beam for excitation 100 is irradiated is wound on the reel 32, so new metal layer 35 always opposes to the focus position 36 of the laser beam 100.

The debris shield device 4 is comprised of a base 41 laid U-shape in a cross-section, a motor 42 fixed to the base 41, a drive reel 43 held on a rotate shaft of the motor 42, a follow reel 44 rotatably held on the base 41 at position spaced from the drive reel 43, a polyethelene film 40 extended between the drive reel 43 and the follow reel 44, and a shield plate 45 disposed between the base 41 and the target drive device 3 and has a through-hole.

All of rotating portions such as a bearing of the rotate shaft of the motor 42, a bearing of the drive reel 43 and a bearing of the follow reel 44 are coated by a vacuum grease or a solid lubricant agent to maintain smooth rotation in the vacuum for a long time. The motor 42 is driven synchronous with repeating frequency of laser beam for excitation.

The debris generated from the target 33 is shielded by the shield plate 45, and the debris passed through the shield plate 45 is shielded by the polyethylene film 40, whereby the debris is prevented from attaching to the laser incidence window 10. Even when some amount of the debris attaches to one part of the polyethylene film 40, another part of the polyethylene film 40 opposes to the laser incidence window 10 by drive of the motor 42, so the permeability for the laser beam of the target 33 is not deteriorated.

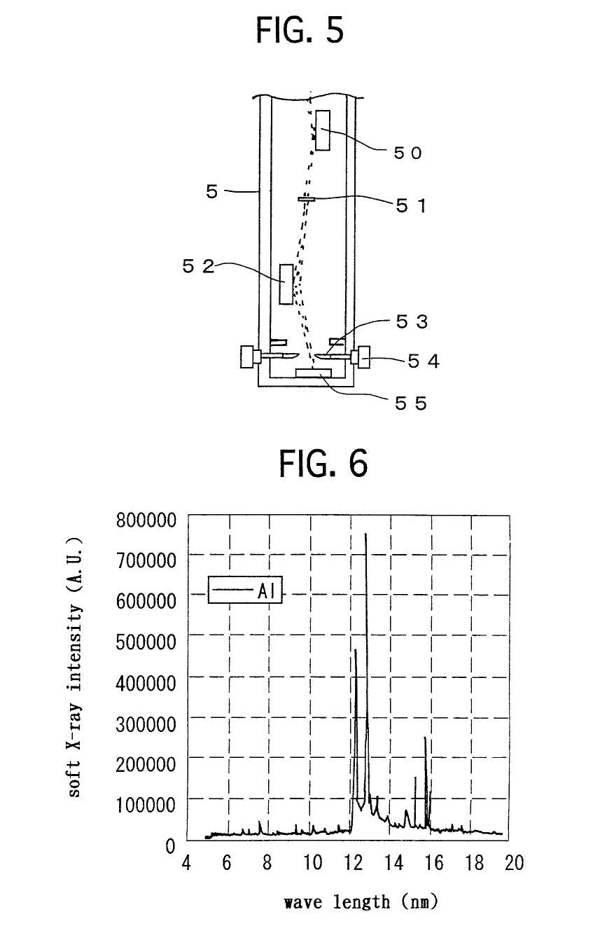

As shown in FIG. 5, the plane image-forming type incidence spectroscope 5 is provided with a focus mirror 50 and a slit 51, and further provided with a diffraction grating 52 as the wavelength disperse device ahead of them. The focus mirror 50 has atroidal reflect surface so that the electromagneticwave perpendicular to the reflect surface is focused by the slit 51. Ahead of the diffraction grating 52, a space slit 53 and a linear introduce device 54 to which the space slit 53 is fixed are provided as the wavelength select device so that the space slit 53 is moved finely by drive of the linear introduce device 54. Distance L from center of the diffraction grating 52 to the space slit 53 is 235 mm. Adjacent to the space slit 53 a wafer 55 is disposed.

In the plane image-forming type incidence spectroscope 5, the electromagneticwave focused by the focus mirror 50 passes through the slit 51 and is dispersed by the diffraction grating 52 according to the wavelength. The electromagneticwave of each wavelength dispensed etches the wafer 55.

According to the laser plasma EUV light source apparatus of this embodiment, by continuous rotating the reels 31 and 32 the target 33 is supplied to the focus position 36 of the drive laser beam continuously, and is supplied intermittently if the reels 31 and 32 are rotated intermittently. In this way, the laser plasma EUV light source apparatus can be driven continuously for a long time.

Also, according to the laser plasma EUV light source apparatus of this embodiment, using the tape-like target 33 comprised of the film layer 34 and the metal layer 35 can restrict generation of the debris, and can supply new surface of the metal layer 35 continuously. In this way, attachment of the debris to the laser incidence window 10 and each portions in the plane image-forming type incidence spectroscope 5 is restricted. The electromagneticwave of wavelength in the EUV area can be generated and used stably for a long time by repetition of high frequency not less than several kHz.

(Experiment Sample)

By the above mentioned laser plasma EUV light source apparatus, spectrums of the electromagneticwaves generated are measured by changing construction of the target variously. In measuring, a filter to select wavelength is used to cut wavelength not more than 12.4 nm.

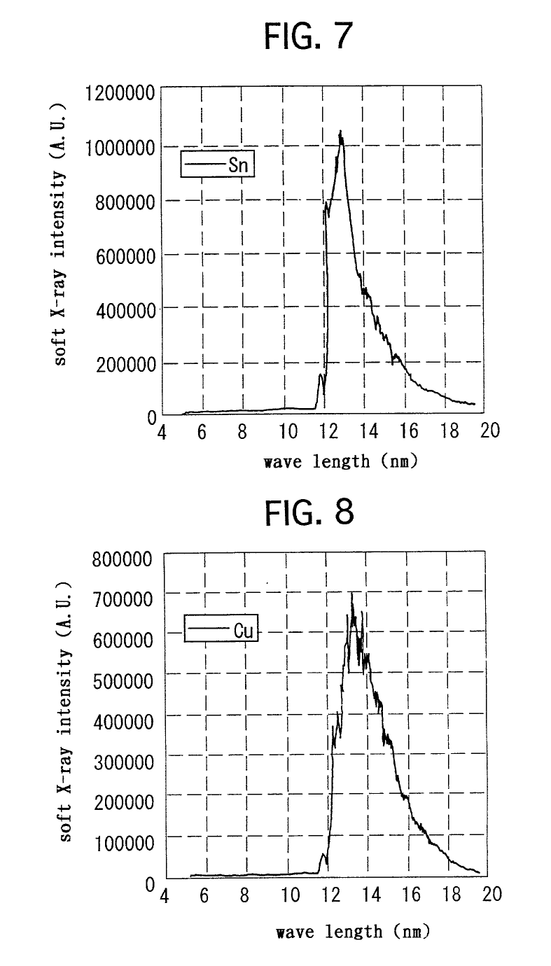

The spectrum of the target 33 in which thickness of the film layer 34 is 50 μm and metal layer 35 is made of aluminium is shown in FIG. 6. The spectrum of the target in which Sn is used as the metal layer 35 is shown in FIG. 7, and the spectrum of the target in which Cu is used as the metal layer 35 is shown in FIG. 8. In any cases thickness of the metal layer 35 is 10 μm.

AS apparent from these, the spectrum of Al is a line spectrum while spectrums of Sn and Cu are continuous spectrums. The continuous spectrum is convenient for the wavelength dispersion and wavelength selection, which means Sn and Cu is desirable for the target.

Next, relation between material of the metal layer 35 and generated amount of the debris is examined. Here, it is reported that the metal around the focus position is melted by irradiation of the energy beam and is blown by interact operation between energy of the plasma and the energy beam to generate the debris. So, it is prospected as a melting point of the metal of metal layer 35 becomes higher, and amount of the debris generated becomes smaller. That is, debris amount of the metal layer 35 made of Sn is larger than that of the metal layer 35 made of Al, and debris amount of the metal layer 35 made of Al is larger than that of the metal layer 35 made of Cu.

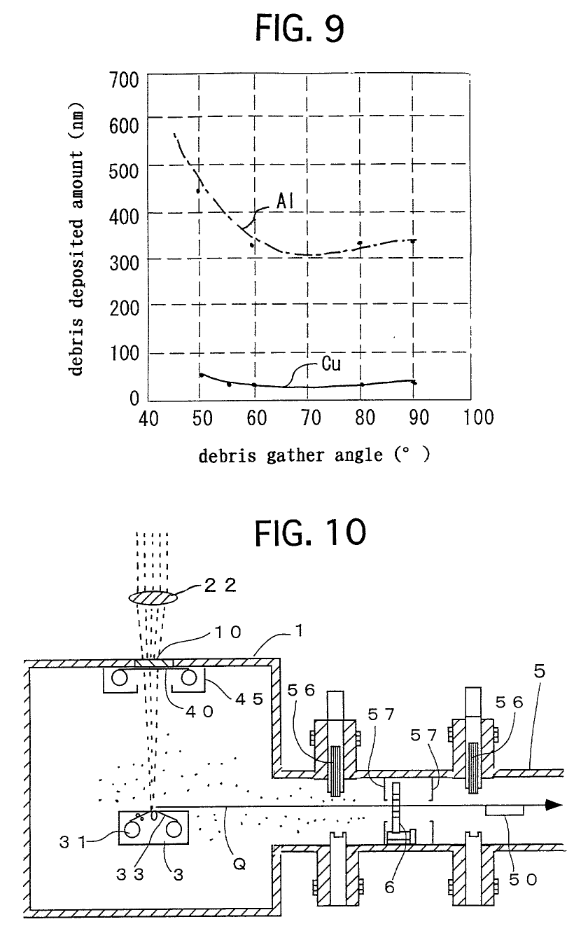

In view of this, two targets 33 each having the metal layer 35 made of Al and Cu and having thickness of 10 μm are prepared, and deposited amounts of the debris are measured by the laser plasma EUV light source apparatus of this embodiment. In measuring, a silicon wafer is disposed in the vacuum chamber 1 of the laser plasma EUV light source apparatus, the energy beam is irradiated to the target 33 by two hundred thousands (200,000) times, and deposited amount of the debris on the silicon wafer is measured by contact-type step meter. Here, an angle of the target 33 relative to the focus position 36 is changed variously. Result of these measurement are shown in FIG. 9. It is apparent that deposited amount of the debris of Cu is extremely smaller than that of Al, which means Cu is especially desirable target material.

Next, thickness of the metal layer 35 is examined. To an aluminium plate as the target the energy beam is irradiated once by the laser plasma EUV light source apparatus of this embodiment. As a result, area corresponding to diameter of about 500 μm and depth of about 100 μm, which is larger than amount necessary to generate the electromagneticwave of wavelength in the EUV area, is peeled off. It is assumed that such deep peel-off results from interaction of the energy of plasma and the energy beam, as mentioned above.

In view of the above, on surface of the polyethylenetelephtarete film having thickness of 50 μm, aluminium foil of different thickness is adhered by an adhesive agent etc. to form an aluminium layers, thus preparing plural kinds of tape like targets 33. To these targets 33 the energy beam is irradiated once by the laser plasma EUV light source apparatus of this embodiment, to calculate thickness of the metal layer 35 in which the film layer 34 does not appear As a result, thickness of 1 to 10 μm of the aluminium layer is sufficient and the electromagneticwave of wavelength in the EUV area equivalent to that of the aluminium plate is generated.

Thickness of 20 μm of the metal layer 35 is sufficient at the most for generating the electromagneticwave, but intensity of the metal foil is insufficient in this thickness. In view of this, in the target of the present invention, the polymer film and the metal layer are laminated. As the polymer film, available and cheaper target having thickness of 10 to 100 μm can be used.

Next, feed speed of the target 33 by the target drive device 3 is examined. As mentioned above, diameter of an irradiated track when the energy beam has been irradiated once is 500 μm, and five thousands (5000) shot are made per one second, provided that frequency of the energy beam is 5 kHz. So, new surface of the metal layer 35 can be positioned at the focus position 36 securely by feeding the target 33 in speed faster than 5 m/sec., However, if the target 33 is fed by this speed for one hour continuously for irradiation, length of the target 33 reaches up to 18000 m, that is, wound thickness thereof reaches up to about 0.78 m provided that diameter of a wind core is 5 mm and thickness of the target 33 is 100 μm. Accordingly, the wound thickness reaches to about 22 m for continuous irradiation for working time (8 hours). Consequently, not only size of the vacuum chamber 1 becomes large, but distance from the plane image-forming type incidence spectroscope 5 to the focus position 36 becomes longer to generate large loss of the energy beam.

For this reason, the laser device 2 desirably has the beam vibrate means vibrating the energy beam in a plane including an extract direction of the electromagneticwave of wavelength in EUV area. As the beam vibrate means, a vibrate-type mirror 23 shown in FIG. 2 can be used. By setting amplitude of the vibrate type mirror 23, 20 mm, the energy beam is vibrated in a plane including a width direction and perpendicular to a moving direction of the tape-like target 33, forty irradiated tracks can be arranged side by side in the width direction of the target 33. Provided that frequency of the energy beam is 5 kHz, 125 shots are sufficiently made for one second in the length direction of the target 33.

Accordingly, provided that amplitude of the vibrate-type mirror 23 is 20 to 40 mm, the target 33 can be fed by feeding speed of 62 to 125 mm/sec. corresponding to frequency of 125 to 250 Hz. Length of the target 33 per one hour is 4500 m, and wound thickness of the target 33 for 8 hours is about 3.5 m. Thus, the apparatus can be compact.

(Embodiment 2)

By the way, when Cu is used as the metal layer 35, the debris deposites by about 71 μm even at a position spaced by 300 mm from the focus position 36 of the target 33 provided that 1.6×10¹¹ shots are made. Such amount of the deposited debris prevents reflection of the optical elements used in the plane image-forming type incidence spectroscope 5.

In view of this, in the laser plasma EUV light source apparatus of this embodiment, as shown in FIG. 10, at a root portion of the plane image-forming type incidence spectroscope 5, a pair of shutters 56 spaced are provided. Between paired shutters 56 a pair of shield plates 57 each having an opening of area 4 mm² are disposed and between the paired shield plates 57 a shield device 6 is disposed. Another construction of the embodiment 2 is same as that of the embodiment 1. In front of the ahead shutter 56 a focus mirror 50 is disposed.

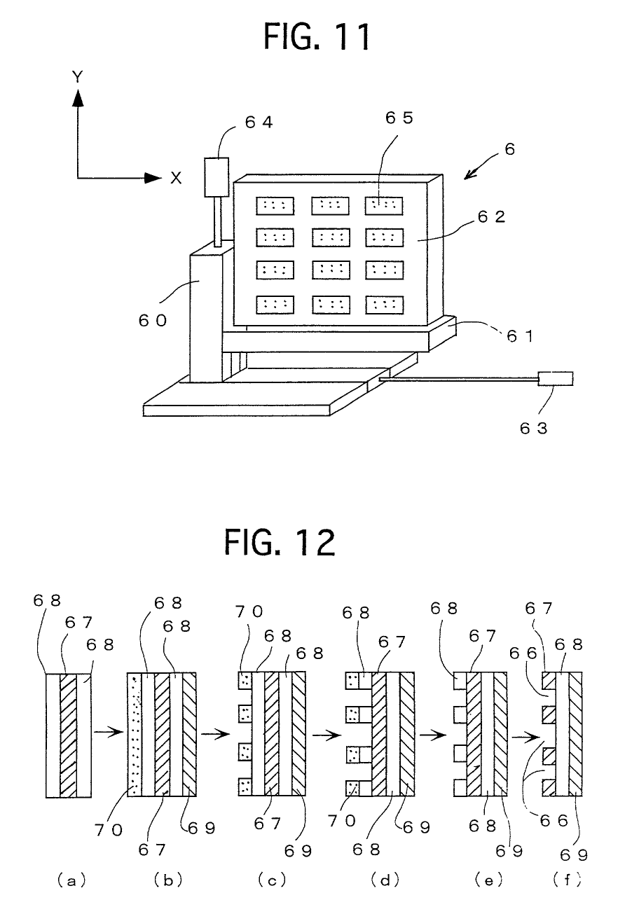

As shown in FIG. 11, the shield device 6 is comprised of X-Y stage including a X stage 60 and a Y stage 61, and a shield portion 62 held on the X-Y stage 60. The shield portion 62 is perpendicular to an optical axis Q of the electromagneticwave of wavelength in the EUV area. The X stage 60 and the Y stage 61 are movable respectively in a X direction and a Y direction, and are driven by knobs 63 and 64 protruded external of the plane image-forming type incidence spectroscope 5. On the shield portion 62, three windows are arranged in lateral direction and four windows 65 are arranged in vertical direction, and one of the twelve windows 65 positions on the optical axis Q by moving the X-Y stage by operation of the knobs 63 and 64.

As shown in FIG. 12 (f), the shield portion 62 is comprised of a grate-like silicon base plate 67 having twelve openings 66 forming the windows 65, a silicone nitride film 68 formed on one whole surface of the base plate 67 and covers the openings 66, and a silicon dioxide film 69 formed on one whole surface of the silicon nitride film 68. Thickness of the silicon base plate 67 is 500 μm, area of the openings 66 is same (4 mm²) as that of opening of the shutter 56. Thickness of the silicone nitride film 68 is 0.05 to 0.1 μm, and thickness of the silicon dioxide film 69 is 0.05 μm.

Next, a manufacturing method of the shield portion 62 will be explained with reference to FIG. 12. Firstly, the silicon base plate 67 not having a openings 66 is prepared, and both surfaces are subjected to the nitride treatment by the gas nitride method to form the silicon nitride film 68 having thickness of 0.05 μm, as shown in FIG. 12(a).

As shown in FIG. 12(b), on one surface of the silicon nitride film 68 the silicon dioxide film 69 is formed by the evaporate method, and on other surface of the silicon nitride film 68 a resist layer 70 is formed by coating a resist material. Thickness of the silicon dioxide film 69 is 0.05 μm, and thickness of the resist layer 70 is 2 μm.

The silicon base plate 67 is mounted on an optical stepper device with facing the resist layer 70 upwardly, and a mask pattern of size corresponding to the opening 66 is exposed and transferred. Non-hardened portion is washed and developed, so that, as shown in FIG. 12(c), the pattern having openings corresponding to the openings 66 are transferred to the resist layer 70.

Next, the silicon nitride film 68 appeared through openings of the resist layer 70 is etched by the reactive ion etching (RIE) method with using gas in which CF₄ and O₂ are mixed. As a result, as shown in FIG. 12(d), twelve openings are formed on the silicon nitride film 68 and the silicon base plate 67 appears through the openings. Then, as shown in FIG. 12 (e), the resist layer 70 is removed, so the silicon base plate 67 is etched by a tetramethylammonium hydrooxide through opening of the silicon nitride film 68 to form the opening 66. Finally, removing the silicon nitride film 68 having openings, as shown in FIG. 12(f), forms the shield portion 62 having windows 65 comprised of opening of the openings 66.

In the laser plasma EUV light source apparatus having the shield device 6, the electromagneticwave generated is irradiated to the shield portion 62 after passing through opening of the shield plate 57. At the shield portion 62, the electromagneticwave is irradiated on one window 65 positioned on the optical axis Q, permeates the silicon nitride film 68 and the silicon oxide film 69 in this order through the opening 66, and is irradiated to the plane image-forming type incidence spectroscope 5. The debris, being shielded by the shield plate 57 and the shield portion 62, is prevented from entry into the plane image-forming type incidence spectroscope 5. At the window 65 of the shield portion 62, a filter is constructed by lamination of the silicon nitride film 68 and the silicon dioxide film 69, and the window 65 has the smallest opened area needed. For this reason, the shield portion 62 has sufficient intensity against collision of the debris and has excellent durability.

At the shield portion 62, due to attachment of the debris to the window 65 permeability of the electromagneticwave gradually decreases. At the time when permeability of the window 65 positioned on the optical axis Q decreases to some extent, the knobs 63 and 64 are driven manually to position the next window 65 on the optical axis Q. As a result, the electromagneticwave permeates the window 65 comprised of new silicon nitride film 68 and new silicon dioxide film 69, so that permeability of thereof is recovered. Thus, the window 65 can be exchanged with new window 65 without returning pressure to the normal pressure and stopping irradiation of the laser beam for excitation. For this reason, continuous and long utilization of the electromagneticwave can be realized.

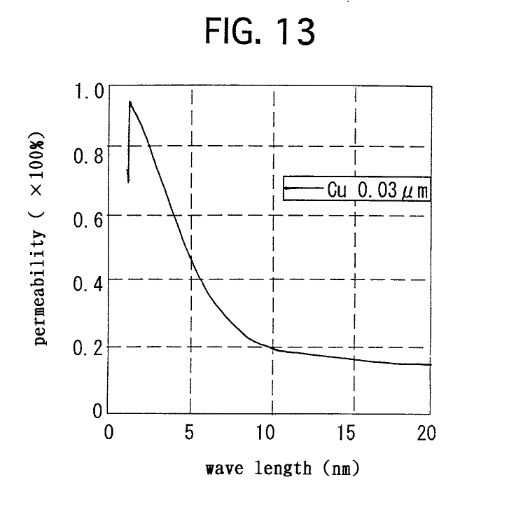

A pulse signal from the laser device 2 is feedbacked to a control device (not shown) to move the X-Y stage corresponding to the number of pulses counted. For example, in case where the shield portion 62 is positioned to be spaced from the focus position 36 of the target 33 by 200 mm, when two hundreds thousands (200,000) shots are made for the target 33 made of Cu, as apparent from FIG. 9, the debris is deposited by 30 nm (0.03 μm) in a debris gather direction angle of 90°. In this thickness of the debris, as shown in FIG. 13, permeability of the electromagneticwave of wavelength of 13 nm decreased down to about 20%.

By simulating thickness of the debris when permeability of the electromagneticwave of wavelength 13 nm reaches to 75% based on the above result, thickness of 5 nm (0.005 μm) can be obtained. This thickness corresponds to five millions (5,000,000) shots and corresponding to about 0.3 hour (about 18 minutes) when frequency is 5 kHz. Accordingly, by moving the X-Y stage in every count of 5,000,000 to position the new window 65 on the optical axis Q, continuous drive of about 3.6 hours can be performed by one shield portion 6

If the quartz vibrator is positioned adjacent to the shield plate 57 and the debris attaches to the shield plate 57, vibrating frequency of the quartz vibrator changes. Based on it, movement and timing for exchange of the window 65 can be judged by detecting such change.

What is claimed is:

1. A target disposed in a laser plasma EUV light source apparatus for generating an electromagneticwave of wavelength in EUV area by irradiation of energy beam,
the target comprising a polymer film having film thickness of 10 to 100 μm, and a target material held in the polymer film.

2. A target according to claim 1, wherein the target material comprises Al, Cu, Sn, Si or an alloy thereof.

3. A target according to claim 1, wherein the target material forms a metal layer on a surface of the polymer film and has a layer thickness of 1 to 20 μm.

4. A laser plasma EUV light source apparatus comprising:
a vacuum chamber;
a target disposed in the vacuum chamber;
a beam irradiate means for irradiating energy beam to the target;
an input optical system for introducing energy beam to the target;
an output optical system being communicated with the vacuum chamber for introducing electromagneticwave generated from the target;
a shield device for protecting at least one of the input optical system and output optical system from spattering particle; and
a wave length select device for selecting from electromagneticwave an electromagneticwave at wavelength in a EUV area.

5. A laser plasma EUV light source apparatus according to claim 4, wherein the target is comprised of a polymer film and metal layer formed on a surface of the polymer film and having layer thickness of 1 to 20 μm, and further comprising a target drive device for supplying the target to a focus position of the energy beam continuously or intermittently.

6. A laser plasma EUV light source apparatus according to claim 5, wherein the target is a tape-like target, the target drive device has a drive portion for feeding out the tape-like target and a wind portion for winding up the tape-like target, and the focus position of the energy beam is disposed between the drive portion and the wind portion.

7. A laser plasma EUV light source apparatus according to claim 6, wherein the input optical system has a beam vibrate means for vibrating the energy beam in a plane including an extract direction of the electromagneticwave of wavelength in EUV area.

8. A laser plasma EUV light source apparatus according to claim 7, wherein the vibrating direction of the energy beam is perpendicular to move direction of the tape-like target.

9. A laser plasma EUV light source apparatus according to claim 4, wherein the shield device has a shield film comprised of a silicon nitride film and an reinforce film to protect the output optical system from spattering particles.

10. A laser plasma EUV light source apparatus according to claim 9, wherein the shield device desirably has move means for moving the shield film.
